(19) United States
(12) Patent Application Publication
(10) Pub. No.: US 2012/0239536 A1
(43) Pub. Date: Sep. 20, 2012

(54) INTERACTIVE VIRTUAL SHOPPING EXPERIENCE

(75) Inventor: Eduardo S. C. Takahashi, Redmond, WA (US)

(73) Assignee: MICROSOFT CORPORATION, Redmond, WA (US)

(21) Appl. No.: 13/051,696

(22) Filed: Mar. 18, 2011

(51) Int. Cl. G06Q 30/00; G06F 15/16; G06F 3/048

(52) U.S. Cl. 705/27.1; 715/738

(57) ABSTRACT

Embodiments are disclosed that relate to interactive online shopping experiences. For example, one embodiment provides a computing device configured to present an interactive shopping experience including receiving a user input requesting display of an interactive map of a retail store, and outputting to a display device the interactive map of retail store in response to the request. The embodiment further comprises receiving a user input requesting a first-person view of a portion of the interactive map of the retail store and outputting to the display device the first-person view of the portion of the interactive map of the retail store.

### BACKGROUND

Online shopping is growing increasingly popular, as it may offer benefits over traditional brick-and-motor stores. For example, online shopping may offer a wide range of inventory, easy access, and convenience. However, navigating through shopping websites may be difficult. For example, browsing for a specific product may involve separately navigating through one or more layers of menu pages before reaching a product selection view. Browsing for multiple different types of items may involve repeating such a process for each desired item. Further, unlike in a physical shopping experience in which a user passes by many items displayed on shelves and the like, an online shopper may use a search engine to target a specific product. In this case, the user may not be exposed to other products, thereby limiting cross-selling opportunities.

### SUMMARY

Various embodiments are disclosed herein that relate to interactive shopping experiences. For example, one embodiment provides a computing device configured to present an interactive shopping experience comprising receiving a user input requesting display of an interactive map of a retail store, and outputting to a display device the interactive map of the retail store in response to the request. The embodiment further comprises receiving a user input requesting a first-person view of a portion of the interactive map of the retail store and outputting to the display device the first-person view of the portion of the interactive map of the retail store.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of an interactive virtual shopping environment.

FIG. 2 shows a flow diagram depicting an embodiment of a method of presenting an interactive virtual shopping experience.

FIG. 3 schematically shows a view of an interactive shopping map of a plurality of retail stores according to one embodiment of the present disclosure.

FIG. 4 schematically shows an embodiment of a higher magnification view of a portion of the map of FIG. 3.

FIG. 5 schematically shows an embodiment of a higher magnification view of a portion of the map of FIG. 4.

FIG. 6 schematically shows an embodiment of a first-person view of a portion of the map of FIG. 5.

FIG. 7 schematically shows another embodiment of a first-person view of a portion of the map of FIG. 5.

FIG. 8 shows a flow diagram depicting another embodiment of a method of presenting an interactive virtual shopping experience.

### DETAILED DESCRIPTION

Various embodiments are disclosed herein that relate to providing interactive virtual shopping experiences that may facilitate shopping, selling, cross-selling, advertising, and other such functions in light of the factors discussed above. In a virtual shopping experience according to the present disclosure, a user is presented with an interactive map of a virtual store, wherein the map may include annotations (e.g. labels, legends, or other suitable indicia) that indicate product regions. In some embodiments, a user can navigate to different product regions by zooming in and/or out on the map, wherein zooming in on a region may reveal additional annotation indicating, for example, products contained within each region.

A user may also select to view a first-person view of a desired portion of the interactive map. Such a first-person view may contain images of products on shelves or other displays that the user may select for viewing and eventual purchase, if desired. A user may browse through such aisles as if actually shopping, thereby enabling cross-selling opportunities as in an actual shopping experience.

A user may interact with the virtual map in any suitable manner. For example, as described in more detail below, a user may interact via gestures detected by a depth camera or other three-dimensional input. In some embodiments, a user also may interact via other input devices, such as keyboards, touch screens, hand-held controllers such as video game controllers, remote controllers, hand-held computing devices such as smart phones, or any other suitable input device.

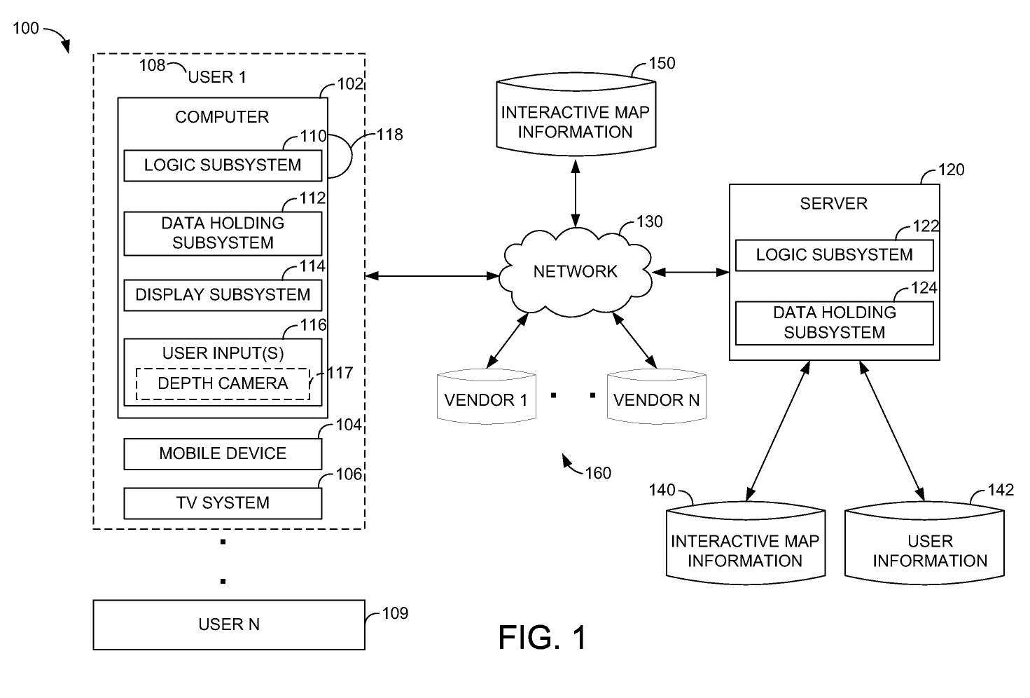

FIG. 1 shows an interactive virtual shopping environment 100 in which a plurality of users may engage in interactive shopping experiences with an interactive shopping server via various end-user devices. In FIG. 1, a computer 102, a mobile device 104, and a television system 106 are shown as being associated with a first user 108. It will be understood that any suitable number of users, indicated as an arbitrary number N of users at 109, may each conduct interactive virtual shopping experiences via one or more different computing devices associated with that user.

Computer 102, mobile device 104, and television system 106 may represent any suitable types of computing devices. Example computers 102 include, but are not limited to, laptop computers, desktop computers, notepad computers, notebook computers, slate computers, mainframe computers, server computers, and/or any other suitable types of computers. Example mobile devices include, but are not limited to, smart phones and other cellular phones, portable media players, portable game systems, etc. Likewise, example television systems 106 may include hardware such as digital video recorders, set-top boxes, video game consoles, and/or any other suitable network devices and/or home entertainment devices.

As illustrated for computer 102, each computing device may include a logic subsystem 110 and a data-holding subsystem 112, wherein the logic subsystem 110 is configured to execute instructions stored within the data-holding subsystem 112 to implement embodiments disclosed herein, among other tasks. Each computing device may further include a display subsystem 114 for displaying information to a user as well as one or more user input devices 116 to receive input from a user, such as keyboards, mice, game controllers, cameras, microphones, and/or touch screens, for example. Further, the user input may comprise depth information received from a depth camera 117. In this manner, the user may provide input to the computer through gestures that are received by a depth camera. These components are discussed in more detail below.

Continuing with FIG. 1, an interactive shopping map server 120, configured to receive, store, and provide interactive maps of retail stores, interacts with the end-user computing devices 102, 104, 106 over a network 130, such as the internet or other computer network. The interactive shopping map server 120 includes a logic subsystem 122 configured to execute instructions, and a data holding subsystem 124 configured to store instructions executable by the logic subsystem 122 to implement embodiments disclosed herein.

The interactive shopping map server 120 may be configured to provide interactive shopping map information to requesting computing devices, and also may maintain user account information. As such, the interactive shopping map server 120 may include or otherwise communicate with an interactive map information store 140 and a user account information store 142. Further, in some embodiments, interactive map information may be stored remotely instead of or in addition to being stored locally, as indicated at 150, such that the server accesses the interactive map information via the network 130. Likewise, user information also may be stored at a remote location.

The interactive map information store 140 may store any suitable type of information. For example, the interactive map information store 140 may store information for rendering a plurality of interactive maps of retail stores at a range of magnifications, annotation information for each interactive map at various magnifications, and/or first-person views of interactive maps. Furthermore, the interactive map information store 140 may store product information, such as that for rendering first person views of products, product descriptions, price information, etc.

Likewise, the user account information store 142 may store any suitable type of user information, including but not limited to identity information, demographic information, billing information, account history information, and other information relevant to online shopping. For example, demographic information may be used to locate targeted advertising for a user. This may allow placement of products that relevant to a user's demographic profile in a first-person shopping view for potential discovery by the user. Likewise, billing and account history information may allow a user to make purchases and to access browsing and/or purchasing histories.

The use environment 100 further comprises one or more vendors 160, such as retailers offering products for sale via an interactive shopping map. The vendors 160 may provide information such as map information, product information (e.g. products available for sale, current inventories, pricing, and the like) to interactive shopping map server 120 and/or to end users 108 and 109. The vendors 160 also may participate in online sales of goods and/or services with end users of the interactive shopping map server 120.

Logic subsystems 110 and 122 each may include one or more physical devices configured to execute one or more instructions. For example, the logic subsystems may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystems 110 and 122 may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystems 110 and 122 may be virtualized and executed by remotely accessible networked computing devices configured in a cloud computing configuration.

The data-holding subsystems 112 and 124 each may include one or more physical, non-transitory, devices configured to hold data and/or instructions executable by the logic subsystem to implement the herein described methods and processes. When such methods and processes are implemented, the state of the data-holding subsystems 112 and 124 may be transformed (e.g., to hold different data).

The data-holding subsystems 112 and 124 may include removable media and/or built-in devices. The data-holding subsystem 112 and 124 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. The data-holding subsystems 112 and 124 may include devices with one or more of the following characteristics: volatile, nonvolatile, dynamic, static, read/write, read-only, random access, sequential access, location addressable, file addressable, and content addressable. In some embodiments, the logic subsystem 110 and data-holding subsystem 112 (and logic subsystem 122 and data-holding subsystem 124) may be integrated into one or more common devices, such as an application specific integrated circuit or a system on a chip.

FIG. 1 also shows an aspect of the data-holding subsystem in the form of removable computer-readable storage media 118, which may be used to store and/or transfer data and/or instructions executable to implement the herein described methods and processes. Removable computer-readable storage media 118 may take the form of CDs, DVDs, HD-DVDs, Blu-Ray Discs, EEPROMs, and/or floppy disks, among others.

It is to be appreciated that the data-holding subsystems 112 and 124 each include one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

Display subsystem 114 may be used to present a visual representation of data held by data-holding subsystem 112. As the herein described methods and processes change the data held by the data-holding subsystem, and thus transform the state of the data-holding subsystem, the state of display subsystem 114 may likewise be transformed to visually represent changes in the underlying data. Display subsystem 114 may include one or more display devices utilizing virtually any type of technology. Such display devices may be combined with logic subsystem 110 and/or data-holding subsystem 112 in a shared enclosure, or such display devices may be peripheral display devices.

It will be understood that each depicted computing device may include a communication subsystem configured to communicatively couple computer 102 with one or more other computing devices. Communication subsystem may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computer 102 to send and/or receive messages to and/or from other devices via a network such as the Internet.

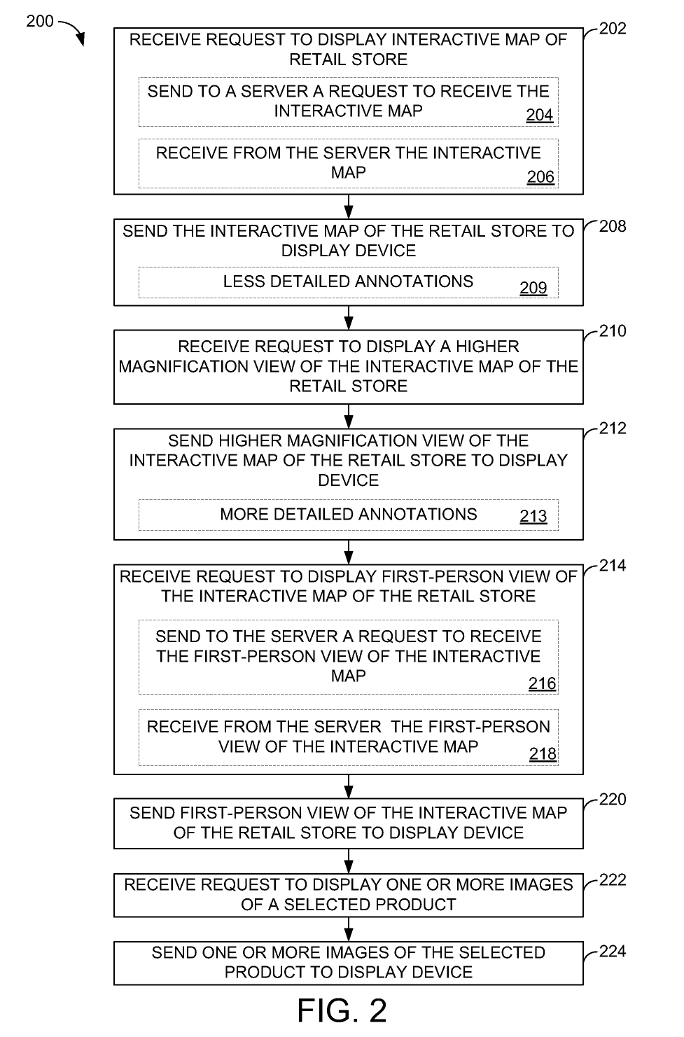

FIG. 2 shows a flow diagram depicting a method 200 for presenting an interactive virtual shopping experience on a computing device. The method 200 comprises, at 202, receiving at an end-user computing device a user input requesting display of an interactive map of a retail store. The user input may request any suitable view of any suitable interactive shopping map. For example, the user input may request an overhead map view of a selected retail store, and may include annotations indicating, for example, each product region of the store. Likewise, the user input may request an overhead view of a larger shopping district, such as a map of a shopping mall, a map of a commercial district of a town or city, or any other suitable view having any suitable annotations.

In some embodiments, the requested map information may be stored locally. In other embodiments, as described above, the interactive shopping map information may be stored on a remote server. As such, process 202 may further comprise sending to an interactive shopping map server a request to receive the interactive map at 204, and receiving from the server the interactive map at 206. The map is then sent to the display device at 208.

The interactive map may comprise annotations of various detail to indicate the types of products contained within that portion of the map. For example, the interactive map that is sent at 208 may contain less detailed annotations 209 to present a general overview of the broad product regions contained within the interactive map.

As mentioned above, an interactive shopping map may be configured to be displayable at a range of magnifications. For example, a user may request to view an entire interactive map at a low magnification, and then zoom in on a desired portion of the interactive map for a higher magnification view of that portion. Thus, method 200 comprises, at 210, receiving a user input requesting display of a higher magnification view of the interactive map, for example, a view of a map of a specific retail store or portion of a retail store. In response to the request, method 200 comprises, at 212, sending the higher magnification view of the interactive map to the display device for display to the user. The higher magnification view of the interactive map may comprise more detailed annotations 213 than the annotations 209, to indicate more detailed and specific product groups contained within the higher magnification view of the interactive map.

In some embodiments, information such as annotations and fine-resolution map information for all possible magnification levels of a map may be sent to a computing device by the server when a specified map is first requested. In other embodiments, map data for a subset of possible magnification levels of a map may be initially received, and further information for additional magnification levels received upon request.

Continuing with FIG. 2, at process 214, a user input requesting display of a first-person view of the interactive map of the retail store is received. Any suitable first-person view may be presented. For example, a first-person view may comprise an eye-level view of the retail store including products displayed on shelves, as described in more detail below. The view may be provided from an actual estimated eye level of a user (e.g. from data acquired from a depth camera system), or from a pre-selected eye level. Further, the first-person perspective may be a true first-person perspective such that no avatar is shown on the display, or may be positioned somewhat behind a true first-person perspective such that a user views and controls an avatar (not shown) moving through the first-person shopping environment. Such an avatar may have any suitable appearance. For example, such an avatar may take the form of a full body, of one or more limbs pushing a shopping cart, of a limb reaching out for a selected product when a user selects a displayed product for view, or any other suitable form. It will be understood that “first person perspective” as used herein indicates any such view that presents a front perspective shopping view of displayed products, as compared to an overhead map view of a store.

In some embodiments, the data for displaying the first-person view may be stored locally, for example, where the data was received from a server in response to a previous request for map data. In other embodiments, the data for displaying the first-person view may not be locally stored when the user input requesting the first-person view is received. As such, process 214 may further comprise, at 216, sending to the server a request for data representing the first-person view of the interactive map, and at 218, receiving from the server the data representing the first-person view of the map. The first-person view of the interactive map is then rendered and output to the display device at step 220 for presentation to the user.

As described above, the first-person view may contain images of products contained on shelves that may be selected by a user for closer examination and/or purchase. As such, method 200 comprises receiving a user input requesting to display one or more images of a selected product at 222. In response to the request, the one or more images of the selected products are output to the display device at 224.

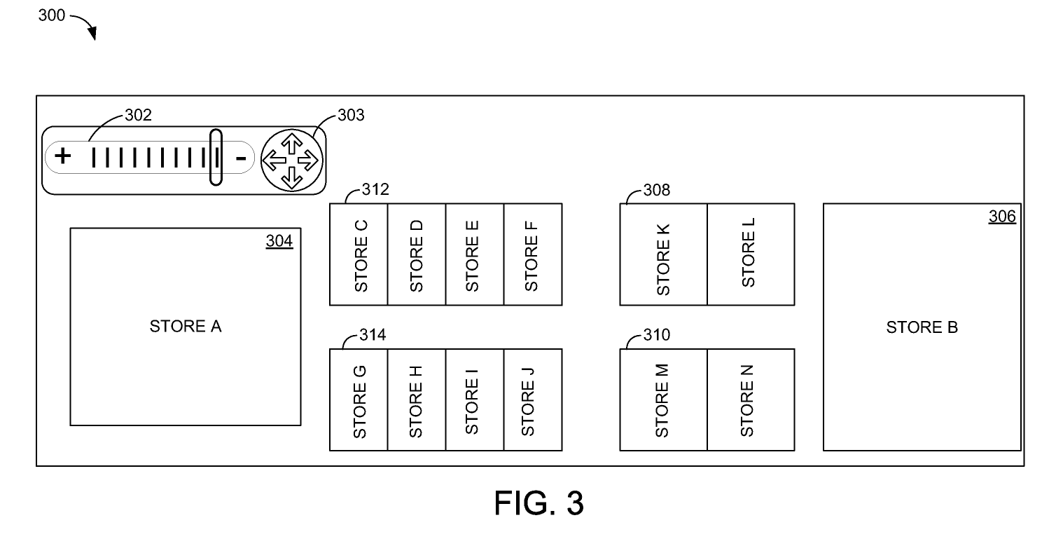

The overhead views and first person views of an interactive shopping map may have any suitable appearance. FIGS. 3-7 show example embodiments of overhead and first-person views of an example interactive shopping map. Referring first to FIG. 3, an interactive map 300 of a mall or portion of a mall comprising a plurality of retail stores is shown. In this view, a user may be presented with various retail stores in which virtual shopping is available, and may zoom in on a selected store in the map for more information on what is offered in the store. In some embodiments, a magnification indicator 302 may be depicted that allows a user to see a current magnification level compared to an available range. The magnification indicator 302 also may act as a user interface control with which a user may interact to change a magnification level of a map. In other embodiments, a user may change a magnification in any other suitable manner, for example, via gestures detected by a depth-sensing camera.

A navigation control 303 also may be provided to allow a user to navigate to different portions of the interactive map. Likewise, other user interface objects (not shown) may provide an indication of the portion of the map being viewed, a direction the map is being viewed from, and other such navigational information.

As indicated by the magnification indicator 302, the interactive map is being displayed at a low magnification. At this magnification, a plurality of retail stores can be seen. It will be understood that the map 300 may depict an actual shopping mall or shopping district, or a virtual shopping area with no real-world counterpart.

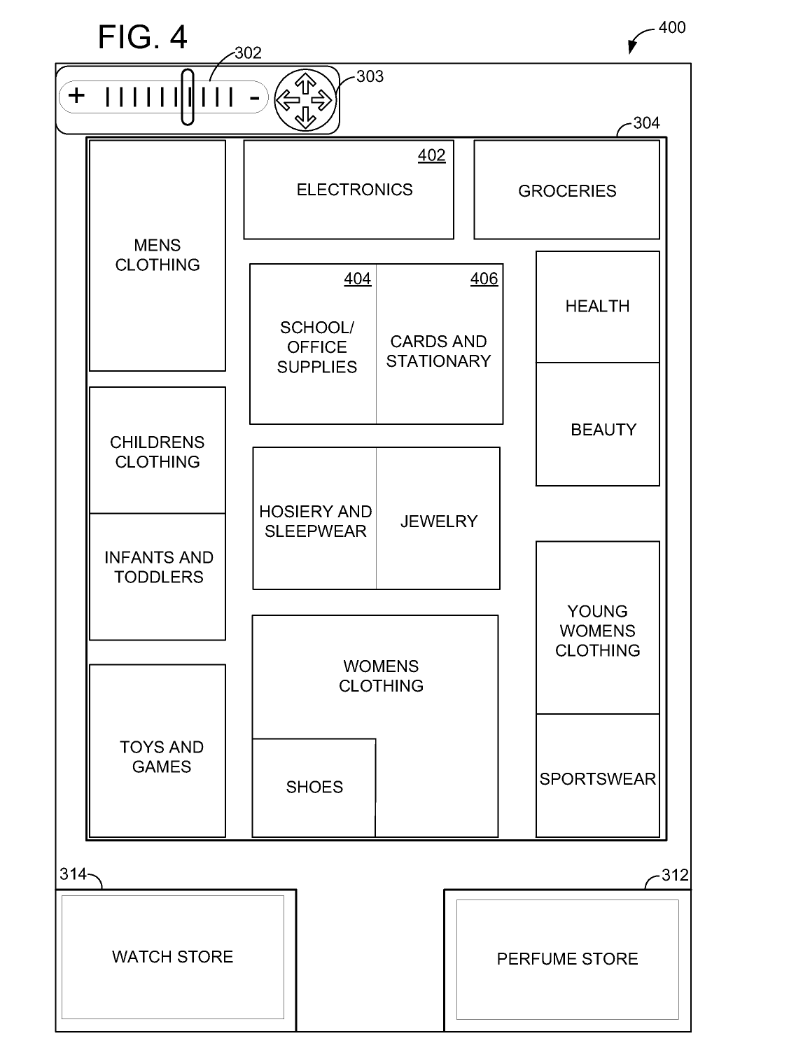

FIG. 3 depicts two large-sized retail stores 304 and 306, two groups of medium-sized retail stores 308 and 310, and two groups of small-sized retail stores 312 and 314. Upon requesting a higher magnification, a more detailed view of a portion of the map 300 may be displayed. For example, FIG. 4 schematically shows an interactive map 400 of a portion of the retail store depicted in FIG. 3. Map 400 depicts a higher magnification view of store 304 as well as a portion of two stores from groups 312 and 314, depicted respectively as a perfume store and a watch store. Magnification indicator 302 indicates a higher magnification level than that shown in FIG. 3. It will be understood that the depicted magnification scale is shown for the purpose of example, and is not intended to be limiting in any manner.

Within store 304, various product regions are depicted along with annotations indicating the type of products contained within each region. For example, the depicted annotations show that region 402 contains electronics, region 404 contains school and office supplies, and region 406 contains cards and stationary. The depicted product regions are shown for the purpose of example, and any suitable number of product regions containing any type of product arranged in any order may be displayed.

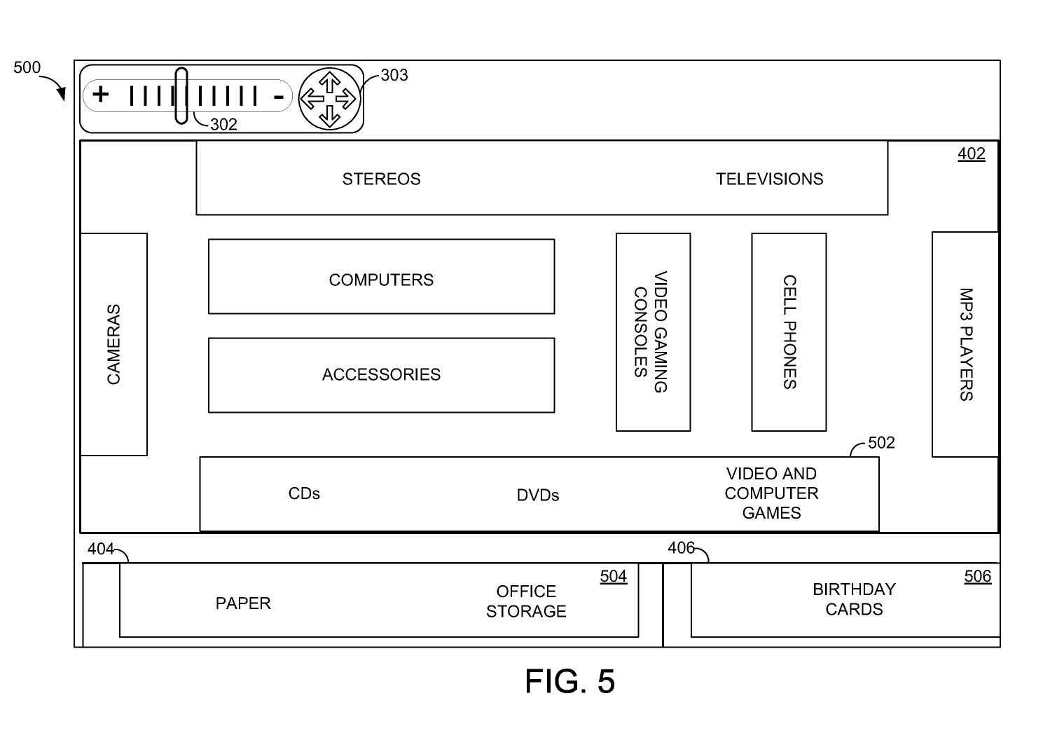

Next, FIG. 5 shows a higher magnification view 500 of the interactive map 400. The magnification indicator 302 shows a higher magnification level than those depicted in FIGS. 3 and 4. In this view, the electronics product region 402 and portions of the product regions 404 and 406 are depicted. More detailed annotations are shown, indicating more detailed product groups within the product regions. For example, product group 502 is annotated to indicate the group contains video and computer games, DVDs, and CDs. Further, product group 504 contains office storage and paper and product group 506 contains birthday cards, for example.

Once a user has navigated to a product group containing products of interest, the user may select to view a first-person view of the interactive map to view products depicted on shelves. The first-person view of the retail store may be depicted as photographs and/or video of an actual retail store, as computer-generated graphics, or a combination of the two.

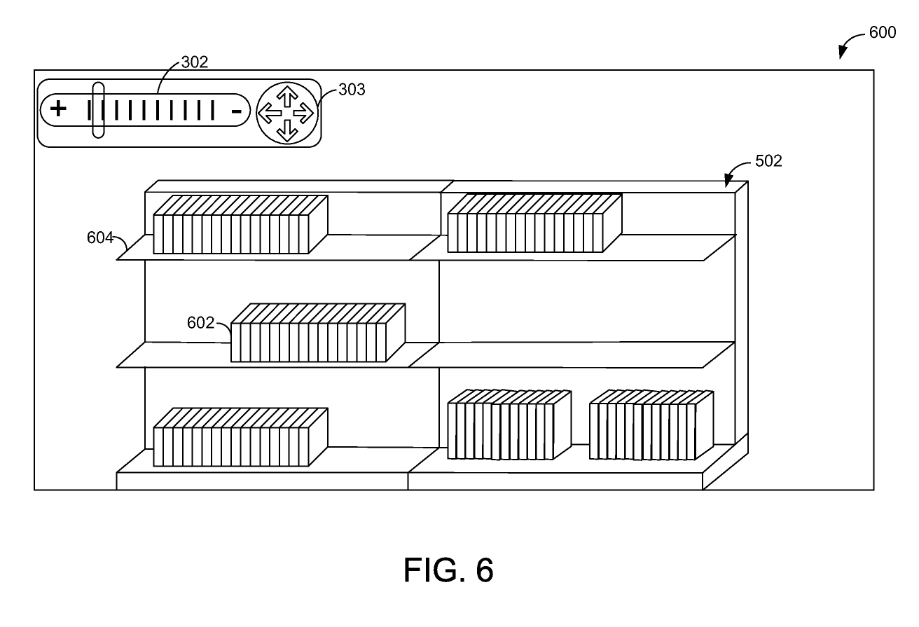

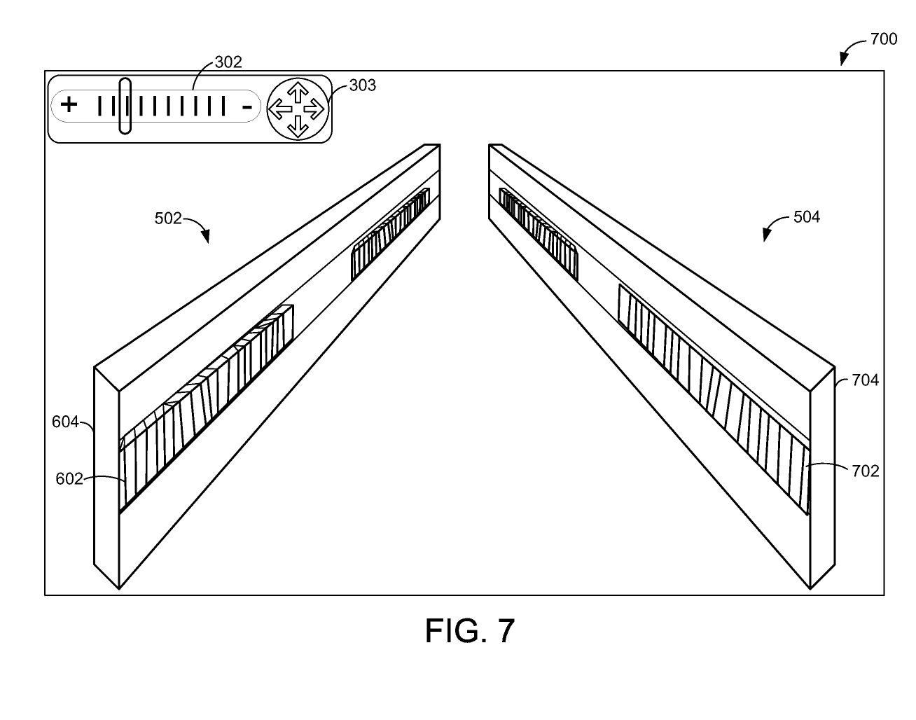

FIGS. 6 and 7 depict embodiments of first-person views of a portion of map 300. In FIG. 6, a head-on view 600 of shelves containing product group 502 is depicted. Magnification indicator 302 indicates the view is near a closest magnification view. In other embodiments, separate magnification indicator scales may be used for the first-person view and the overhead map views. Example products 602 are displayed on shelves 604, which the user is viewing from a head-on perspective. If desired, a user can select a product for closer examination. For example, in some embodiments, a user may activate avatar hand(s) via a depth camera to control the hand(s) to pick up a displayed product. In other embodiments, a user may select a product via a cursor displayed on the display, via a touch-screen input, or in any other suitable manner.

Once selected, a 3D rendering of the product may be displayed, which may be rotated for alternate views. Alternatively, a plurality of images of different perspectives of the product may be presented for display, and the user may select a desired image to view. Additionally, product information may be presented along with the product images. If a user wishes to purchase a product, the user may select the product for purchase in any suitable manner. For example, in some embodiments, a user may control an avatar to place the product into an image of a shopping cart. In other embodiments, a product may be added to a virtual shopping cart by selection via a cursor control device, touch screen or other suitable input device.

FIG. 7 shows another first person view 700 of product groups 502 and 504. Products 602 displayed on shelves 604 are depicted from product group 502. In addition, across an aisle, product group 504 is depicted with additional products 702 displayed on additional shelves 704. As described above with reference to FIG. 6, a user may browse through the first-person view of the interactive store map to locate and examine products, discover new products, etc. The user may rotate the view, for example, using gestures detected by a depth camera or by interacting with navigation control 303, to face either product group 502 or 504, or any other suitable products or group of products. Further, as mentioned above, user demographic information may be used (e.g. by a search engine residing on or otherwise accessible by the interactive shopping map server) to locate products for display in the first person view to a current user. This may help with product discovery and cross-selling for that user.

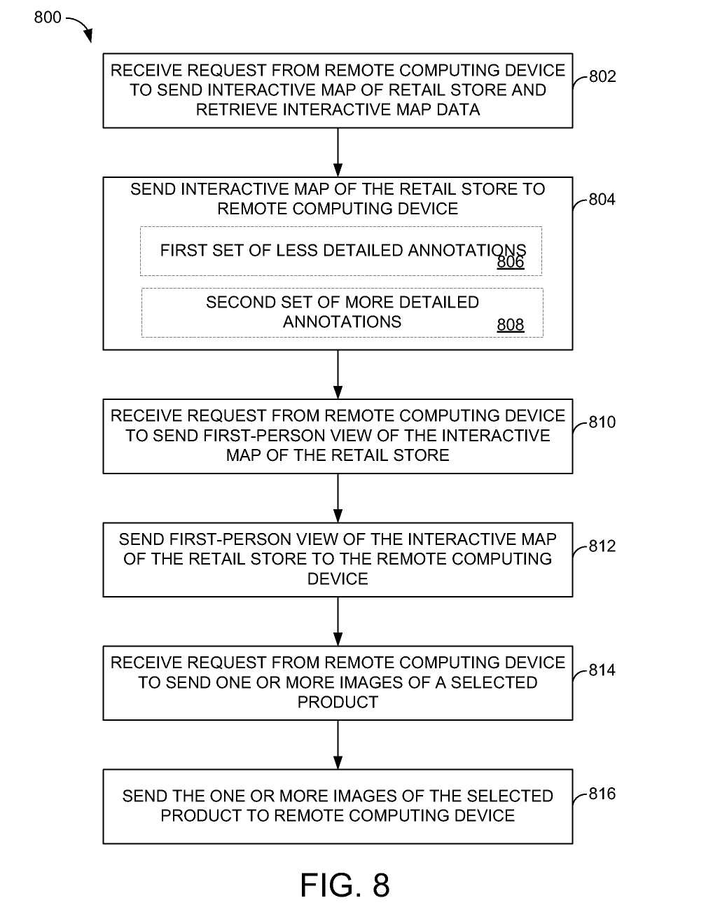

FIG. 8 shows a flow diagram depicting an embodiment of a method 800 of presenting an interactive virtual shopping experience from the point of view of an interactive shopping map server, rather than an end-user device. The method 800 comprises, at 802, receiving a request from a remote computing device to send an interactive map of a retail store, and retrieving the requested interactive map. The interactive map information may be stored locally at the server, or may be retried from a remote location. Next, at 804, the interactive map of the retail store is sent to the remote computing device. In this embodiment, information for including annotations and/or information for displaying the interactive map at different magnifications may be sent with the interactive map. Alternatively, such information may be sent when separate requests are received.

The interactive map may comprise data viewable at lower and higher magnification views, where each view may have a set of annotations, including a first set of less-detailed annotations at 806 viewable at a lower magnification and a second set of more detailed annotations at 808.

Continuing with FIG. 8, at 810, a request is received from the remote computing device to send a first-person view of the interactive map of the retail store. In response to the request, at 812, the first-person view of the interactive map of the retail store is sent to the remote computing device. As described above, the first person view may comprise an eye-level view of the retail store including products displayed on shelves. One or more of these products may be selected by the user for closer examination/and or purchase. At 814, a request is received from the remote computing device to send one or more images of a selected product. In response to the request, the one or more images of the selected product are sent to the remote computing device at 816.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing device, comprising:
a logic subsystem; and
a data-holding subsystem comprising instructions stored thereon that are executable by the logic subsystem to:
receive a user input requesting display of an interactive map of a retail store;
output to a display device the interactive map of retail store in response to the request;
receive a user input requesting a first-person view of a portion of the interactive map of the retail store; and
output to the display device the first-person view of the portion of the interactive map of the retail store.

2. The computing device of claim 1, wherein the instructions are executable to receive a user input requesting a higher magnification view of a portion of the interactive map of the retail store, and output to the display device the higher magnification view of the portion of the interactive map of the retail store in response to the request.

3. The computing device of claim 1, wherein the instructions are executable to output the interactive map of the retail store with annotations indicating a plurality of product regions of the retail store, and wherein the instructions are further executable to:
receive a user input requesting a higher magnification view having more detailed annotations of one or more of the product regions; and
output to the display device the higher magnification view having the more detailed annotations in response to the request.

4. The computing device of claim 1, wherein the instructions are executable to output, in the first-person view, images of one or more products contained within the portion of the map.

5. The computing device of claim 4, wherein the instructions are further executable to receive a user input requesting to view a selected product displayed in the first-person view, and to output to the display device one or more images of the selected product in response.

6. The computing device of claim 1, wherein the user input comprises depth information received from a depth camera.

7. The computing device of claim 1, wherein the instructions are further executable to:
receive a user input requesting display of an interactive map of a plurality of retail stores;
output to the display device the interactive map of the plurality of retail stores;
receive a user input requesting a higher magnification view of a portion of the interactive map of the plurality of retail stores; and
output to the display device the interactive map of the retail store.

8. The computing device of claim 1, wherein the instructions are further executable to:
send to a server a request for the map of the retail store in response to the user input requesting display of the interactive map of the retail store;
receive the interactive map of the retail store from the server in response to the request to display the interactive map of the retail store;
send to the server a request for the first-person view in response to the user input requesting display of the first-person view; and
receive the first-person view in response to the request to display the first-person view.

9. The computing device of claim 1, wherein the instructions are executable to display one or more of photographs of an actual retail store, video of an actual retail store, and/or computer-generated graphics in the first-person view.

10. The computing device of claim 1, wherein the computing device is one or more of a smart phone, laptop, computer, and television system.

11. On a computing device, a method of presenting an interactive virtual shopping experience, the method comprising:
receiving via a user input device a user input requesting display of an interactive map of a retail store;
sending to a display device the interactive map of the retail store comprising less detailed annotations in response to the request;
receiving a user input requesting a higher magnification view of a portion of the interactive map of the retail store;
sending to the display device the higher magnification view of the portion of the interactive map of the retail store comprising more detailed annotations in response to the request;
receiving a user input requesting a first-person view of a portion of the interactive map of the retail store; and
sending to the display device the first-person view in response to the request.

12. The method of claim 11, wherein the user input comprises depth information received from a depth camera.

13. The method of claim 11, wherein the first-person view comprises images of one or more products contained within the portion of the interactive map.

14. The method of claim 11, further comprising, while displaying the first-person view, receiving a user input requesting to view a selected product shown in the first-person view, and sending to the display device one or more images of the selected product in response to the user input requesting to view the selected product.

15. The method of claim 11, further comprising:
sending to a server a request for the interactive map of the retail store in response to the user input requesting display of the interactive map of the retail store;
receiving the interactive map of the retail store from the server in response to the request;
sending to the server a request for the first-person view in response to the user input requesting display of the first-person view; and
receiving the first-person view in response to the request to display the first-person view.

16. The method of claim 11, further comprising:
receiving a user input requesting display of an interactive map of a plurality of retail stores;
sending to the display device the interactive map of the plurality of retail stores in response to the request;
receiving a user input requesting a higher magnification view of a portion of the interactive map of the plurality of retail stores; and
sending to the display device the interactive map of the retail store in response the user input requesting the higher magnification view.

17. A computing device, comprising:
a logic subsystem; and
a data-holding subsystem holding instructions executable by the logic subsystem to:
receive from a remote computing device a request to send an interactive map of a retail store;
send the interactive map of the retail store to the remote computing device;
receive from the remote computing device a request to send a first-person view of a portion of the retail store;
send the first-person view of the portion of the retail store to the remote computing device, the first person view comprising images of one or more products in the portion of the retail store;
receive a request from the remote computing device to send one or more images of a selected product; and
send the one or more images of the selected product to the remote computing device.

18. The computing device of claim 17, further comprising sending a plurality of annotations with the interactive map of the retail store, the plurality of annotations including a first set of annotations for display at a lower magnification view of the interactive map and a second set of annotations for display at a higher magnification view of the interactive map.

19. The computing device of claim 17, wherein the interactive map of the retail store is a lower magnification view of the interactive map having a first set of annotations for display at the lower magnification view, and wherein the instructions are further executable to:
receive from the remote computing device a request to send a higher magnification view of the interactive map; and
send to the remote computing device the higher magnification view of the interactive map having a second set of annotations for display at the higher magnification view.

20. The computing device of claim 17, wherein the instructions are executable to:
receive from the remote computing device a request to send an interactive map of a plurality of retail stores;
send the interactive map of the plurality of retail stores to the remote computing device;
receive from the remote computing device a request to send a higher magnification view of a portion of the interactive map of the plurality of retail stores; and
send the interactive map of the retail store to the remote computing device.
